(19) United States
(12) Patent Application Publication
(10) Pub. No.: US 2025/0269620 A1
(43) Pub. Date: Aug. 28, 2025

(54) SYSTEM OF PRESSURE INTENSIFIER UNITS, METHOD OF CONTROLLING SAME AND RELEVANT COMPUTER PROGRAM, AND PRESS APPARATUS COMPRISING SAID SYSTEM

(71) Applicant: Quintus Technologies AB, Västerås (SE)

(72) Inventors: Per BURSTRÖM, Västerås (SE); Johan ENGLÉN, Västerås (SE); Martin SÖDERLUND, Västerås (SE)

(73) Assignee: Quintus Technologies AB, Västerås (SE)

(21) Appl. No.: 18/857,621

(22) PCT Filed: Apr. 27, 2022
(86) PCT No.: PCT/EP2022/061218

§ 371 Date: Oct. 17, 2024

(51) Int. Cl. B30B 15/16

(52) U.S. Cl. CPC B30B 15/166

(57) ABSTRACT

A system comprising a plurality of pressure intensifier units configured to increase the pressure in a pressure vessel, each pressure intensifier unit comprising an inlet and an outlet configured to be connected to the pressure vessel, at least one first chamber in fluid communication with the inlet and the outlet, respectively, a body controllably movable within a second chamber along a path back and forth between a first end position and a second end position, and an actuating mechanism configured to controllably move the body back and forth between the first end position and the second end position at an adjustable speed. A control and/or processing unit is configured to control the actuating mechanisms of the pressure intensifier units such that each of the bodies has a selected position in the corresponding second chamber in relation to the position(s) of the other body or bodies in its or their corresponding second chamber(s), and, subsequently, carry out a pressure increasing phase.

### TECHNICAL FIELD

The present invention generally relates to the field of high-pressure technology, in particular pressure treatment. More specifically, the present invention relates to a system and a method in a system, the system comprising a plurality of pressure intensifier units each of which is configured to increase the pressure in a pressure vessel for holding pressure medium, by feeding pressure medium into the pressure vessel. The system and the method are generally directed to controlling operation of the pressure intensifier units.

### BACKGROUND

An article to be subjected to pressure treatment by isostatic pressing such as cold isostatic pressing (CIP), warm isostatic pressing (WIP) or hot isostatic pressing (HIP) may be positioned in a pressure vessel arranged to hold pressure medium therein. A treatment cycle may comprise loading the article in the pressure vessel, closing and sealing the pressure vessel, treating the article in the pressure vessel, opening the pressure vessel, and unloading the article from the pressure vessel. Several articles may be treated simultaneously. The treatment cycle may be divided into several parts, or phases. After loading an article into the pressure vessel, the pressure vessel may then be sealed, followed by introduction of a pressure medium (e.g., comprising water) into the pressure vessel such that the pressure in the pressure vessel is increased to a certain pressure level, which may be referred to as a pressurization phase, whereby the article may be subjected to an increased pressure during a selected period of time. The treatment cycle may comprise a heating phase, wherein the pressure medium is heated, e.g., so as to achieve a desired or required temperature thereof. The heating phase may be carried out concurrently with the pressurization phase, before the pressurization phase, or after the pressurization phase. The subjecting of the article to an increased pressure in the pressure vessel during a selected period of time may be referred to as a pressing phase of the treatment cycle. After the pressing phase and prior to opening the pressure vessel to remove the article, the pressure in the pressure vessel is generally decreased to a sufficiently low level by withdrawing pressure medium from the pressure vessel. This may be referred to as a pressure reduction phase or pressure relief phase. The treatment cycle may further comprise a cooling phase. Depending on the type of isostatic press employed (e.g., whether the isostatic press is configured to carry out CIP, WIP or HIP), a cooling phase may however not be necessary.

Depending on the application, it may be desired or even required to achieve a pressure in the pressure in the pressure vessel as high as 6000 bar, or even higher. In order to increase the pressure in the pressure vessel during the pressurization phase, pumps, such as hydraulic pumps, may be used to introduce pressure medium into the pressure vessel in order to increase the pressure in the pressure vessel. However, such pumps may not be capable of generating a pressure in the pressure vessel as high as 6000 bar, and may only be practically utilized for generating a (much) lower pressure in the pressure vessel. This may for example be due to that constructional materials used in such pumps may not be able to withstand the desirable pressure level, at which the mechanical stress on components of the pumps such as valves and piping may be deleteriously high such that the components may break after a relatively short time of use of the pumps. Therefore, such pumps are often used to generate a pressure in the pressure vessel to a pressure level that the pump can safely withstand, followed by further pressurization by means of other devices that can withstand the desirable pressure level. Such other devices may be constituted by so-called pressure intensifiers.

### SUMMARY

While such pressure intensifiers may be designed to be able to withstand very high pressure levels, moving parts of the pressure intensifiers may still be subject to considerable wear due to the high pressure to which the moving parts may be subjected if the desirable pressure level is as high as 6000 bar. Further, at such very high pressure levels, there may be relatively large vibrations caused by the moving parts of the pressure intensifiers, by pressure fluctuations in the pressure medium that is fed to the pressure vessel, and by operation of any hydraulic mechanism of the pressure intensifiers, which may result in noise levels that may impair the working environment for an operator of an apparatus including the pressure intensifiers, such as an isostatic press.

In view of the above, a concern of the present invention is to provide means for reducing the wear on moving parts of the pressure intensifiers or on other components of the pressure intensifiers subject to high pressures, particularly when the pressure intensifiers are used to achieve a pressure in a pressure vessel as high as 6000 bar, or even higher.

A further concern of the present invention is to provide means for reducing noise or the perceived noise harmonics resulting from any vibrations caused by the moving parts of the pressure intensifiers, by pressure level fluctuations in the pressure medium flow that is fed from the pressure intensifiers to the pressure vessel, and by operation of any hydraulic mechanism of the pressure intensifiers, particularly when the pressure intensifiers are used to achieve a pressure in a pressure vessel as high as 6000 bar, or even higher.

To address at least one of these concerns and other concerns, a system and a method in a system in accordance with the independent claims are provided. Preferred embodiments are defined by the dependent claims.

According to a first aspect of the present invention, a system is provided. The system comprises a plurality of pressure intensifier units. Each pressure intensifier unit is configured to increase the pressure in a pressure vessel for holding pressure medium by feeding pressure medium into the pressure vessel. Each pressure intensifier unit comprises an inlet configured to continuously or continually receive pressure medium, e.g., from a pressure medium source. Each pressure intensifier unit comprises an outlet configured to be connected to the pressure vessel for feeding pressure medium to the pressure vessel. Each pressure intensifier unit comprises at least one first chamber in fluid communication with the inlet and the outlet, respectively, and configured to continuously or continually receive the pressure medium having been received at the inlet. Each pressure intensifier unit comprises a body controllably movable within a second chamber (e.g., of the pressure intensifier unit) along a path back and forth between a first end position and a second end position. Each pressure intensifier unit comprises an actuating mechanism configured to controllably move the body back and forth between the first end position and the second end position at an adjustable speed, with the actuating mechanism being controllable at least with respect to positioning of the body along at least a part of the path. For each pressure intensifier unit, the at least one first chamber, the body and the second chamber are arranged such that by movement of the body at least once between the first end position and the second end position, any pressure medium in the first chamber(s) is forced to the outlet to exit the pressure intensifier unit.

The system comprises at least one control and/or processing unit. The at least one control and/or processing unit is configured to control the actuating mechanisms of the pressure intensifier units such that each of the bodies has a selected position in the corresponding second chamber in relation to the position(s) of the other body or bodies in its or their corresponding second chamber(s), and, subsequently, carry out a pressure increasing phase. The pressure increasing phase comprises, for each pressure intensifier unit, controlling the actuating mechanism to move the body repeatedly back and forth between the first end position and the second end position while adjusting the speed (of the body) for attaining a selected speed, thereby repeatedly forcing pressure medium in the first chamber(s) to the outlet to exit the pressure intensifier unit and to be fed into the pressure vessel. The selected positions of the bodies and/or the selected speed for each pressure intensifier unit are such that during at least a portion of the pressure increasing phase, the bodies of at least some of the pressure intensifier units are in the first end position and in the second end position at different points in time and/or the speed is the same for at least some of the pressure intensifier units.

According to a second aspect of the present invention, a method in a system is provided. The system comprises a plurality of pressure intensifier units. Each pressure intensifier unit is configured to increase the pressure in a pressure vessel for holding pressure medium by feeding pressure medium into the pressure vessel. Each pressure intensifier unit comprises an inlet configured to continuously or continually receive pressure medium, e.g., from a pressure medium source. Each pressure intensifier unit comprises an outlet configured to be connected to the pressure vessel for feeding pressure medium to the pressure vessel. Each pressure intensifier unit comprises at least one first chamber in fluid communication with the inlet and the outlet, respectively, and configured to continuously or continually receive the pressure medium having been received at the inlet. Each pressure intensifier unit comprises a body controllably movable within a second chamber (e.g., of the pressure intensifier unit) along a path back and forth between a first end position and a second end position. Each pressure intensifier unit comprises an actuating mechanism configured to controllably move the body back and forth between the first end position and the second end position at an adjustable speed, with the actuating mechanism being controllable at least with respect to positioning of the body along at least a part of the path. For each pressure intensifier unit, the at least one first chamber, the body and the second chamber are arranged such that by movement of the body at least once between the first end position and the second end position, any pressure medium in the first chamber(s) is forced to the outlet to exit the pressure intensifier unit.

The method according to the second aspect of the present invention comprises controlling the actuating mechanisms of the pressure intensifier units such that each of the bodies has a selected position in the corresponding second chamber in relation to the position(s) of the other body or bodies in its or their corresponding second chamber(s). The method comprises subsequently carrying out a pressure increasing phase, which pressure increasing phase comprises for each pressure intensifier unit controlling the actuating mechanism to move the body repeatedly back and forth between the first end position and the second end position while adjusting the speed for attaining a selected speed, thereby repeatedly forcing pressure medium in the first chamber(s) to the outlet to exit the pressure intensifier unit and to be fed into the pressure vessel. The selected positions of the bodies and/or the selected speed for each pressure intensifier unit are such that during at least a portion of the pressure increasing phase, the bodies of at least some of the pressure intensifier units are in the first end position and in the second end position at different points in time and/or the speed is the same for at least some of the pressure intensifier units.

For each or any pressure intensifier unit, by the actuating mechanism being controllable at least with respect to positioning of the body along at least a part of the path, it may be meant that the actuating mechanism is controllable at least with respect to moving the body to or towards the first end position or to or towards the second end position.

The pressure vessel may for example be included in a press apparatus that may be suitable for treatment of at least one article by means of pressure generated by means of the pressure medium, for example by means of isostatic pressing such as cold isostatic pressing (CIP), warm isostatic pressing (WIP) or hot isostatic pressing (HIP).

The increasing of the pressure in the pressure vessel by means of the pressure intensifier units feeding pressure medium into the pressure vessel, e.g., during the said pressure increasing phase may be carried out subsequently to a pressurization of the pressure vessel employing pumps, such as hydraulic pumps, to introduce pressure medium into the pressure vessel. For example, a pressurization of the pressure vessel employing pumps, such as hydraulic pumps, to introduce pressure medium into the pressure vessel, may first be carried out in order to reach a certain pressure level of the pressure in the pressure vessel, e.g., about 20 bar. Subsequently, the increasing of the pressure in the pressure vessel by means of the pressure intensifier units feeding pressure medium into the pressure vessel and the said pressure increasing phase may be carried out in order to reach a (much) higher pressure level of the pressure in the pressure vessel, e.g., up to 6000 bar or even higher.

As described in the foregoing, the actuating mechanisms of the pressure intensifier units are, prior to the said pressure increasing phase, controlled such that each of the bodies has a selected position in the corresponding second chamber in relation to the position(s) of the other body or bodies in its or their corresponding second chamber(s). And during the subsequent pressure increasing phase, for each pressure intensifier unit the actuating mechanism is controlled to move the body repeatedly back and forth between the first end position and the second end position while adjusting the speed for attaining a selected speed, with the selected positions of the bodies and/or the selected speed for each pressure intensifier unit being such that during at least a portion of the pressure increasing phase, the bodies of at least some of the pressure intensifier units are in the first end position and in the second end position at different points in time and/or the speed is the same for at least some of the pressure intensifier units.

Thus, by means of the system and method according to the first and second aspect of the present invention, respectively, it may be ensured that during the pressure increasing phase, the bodies of at least some, possibly all, of the pressure intensifier units are in the first end position and in the second end position at different points in time. In other words, during the pressure increasing phase not all bodies, or possibly even no bodies, of the pressure intensifier units are in their end positions concurrently during their respective movements back and forth between the first end position and the second end position. It has been found by the inventors that this may facilitate or allow for keeping any pressure level fluctuations in the pressure medium flow that is fed from the pressure intensifiers to the pressure vessel relatively small. In turn, that may facilitate or allow for keeping any vibrations of the bodies and possibly also of other components of the pressure intensifier units or of a system in which the pressure intensifiers are included relatively small during the pressure increasing phase, which in turn may result in less stress and wear on the bodies and possibly also on other components of the pressure intensifier units or of the system in which the pressure intensifiers are included, as well as a more harmonic sound resulting from the operation of the pressure intensifier units, which may lead to a better work environment for an operator of an apparatus including the pressure intensifiers, such as an isostatic press.

By means of the speed possibly being the same for at least some of, or perhaps all of, the pressure intensifier units, it may be ensured that the time between consecutive changes of direction of the body at the end positions is the same or substantially the same for at least some or all of the pressure intensifier units. In other words, the changings of direction of the bodies of the pressure intensifier units at their first and second end positions may be well distributed over time, and may not occur simultaneously for different pressure intensifier units. This may further facilitate or allow for keeping any vibrations of the bodies and possibly also of other components of the pressure intensifier units relatively small during the pressure increasing phase.

By less stress and wear on the bodies and possibly also on other components of the pressure intensifier units, the system—and accordingly also any apparatus, such as a press apparatus, in which the system may be included—may possibly be in operation a longer period of time before having to be taken out of operation for maintenance, replacements or repairs. The system may for example be included in a press apparatus for treating one or more articles by isostatic pressing. With less need for taking the system out of operation for maintenance, replacements or repairs, the cost for treating articles using the press apparatus may be reduced.

Also, by not all bodies, or possibly even no bodies, of the pressure intensifier units being in their end positions concurrently during their respective movements back and forth between the first end position and the second end position during the pressure increasing phase, the overall flow of pressure medium into the pressure vessel (i.e., the combined flow of pressure medium from all of the pressure intensifier units into the pressure vessel) may become relatively steady, or even, over time. In other words, there may be only relatively small fluctuations over time in the overall flow of pressure medium from the pressure intensifier units into the pressure vessel as compared to an average flow level of the pressure medium flow. This is generally desired when increasing the pressure in a pressure vessel by means of pressure intensifiers. By keeping any such fluctuations relatively small, vibrations of the bodies and possibly also of other components of the pressure intensifier units or of a system in which the pressure intensifiers are included may also be kept relatively small.

At least for the case where the pressure medium comprises or is constituted by water, each or any of the plurality of pressure intensifier units may for example include at least one pressure intensifier such as the H2O Jet Intensifier pump manufactured by H2O Jet Inc., the HYPERTRON® High Pressure Pump manufactured by BFT, a STREAMLINE PRO® pump manufactured by KMT Waterjet Systems, or the HyperJet® Intensifier Pump manufactured by Flow Waterjet. In alternative or in addition, each or any of the plurality of pressure intensifier units may for example include at least one compressor.

There may be provided means for supplying or extracting a working medium from components of the pressure intensifier units. For each pressure intensifier unit, such means could for example comprise a source and a sink of working medium (e.g., hydraulic fluid) in fluid communication with the second chamber via a control valve. The control valve may be configured to cause movement of the body within the second chamber, and possibly control the direction of the movement of the body within the second chamber, by controllably supplying at least a portion of the second chamber with working medium and draining working medium from at least a portion of the second chamber. The controllable supplying of at least a portion of the second chamber with working medium and draining of working medium from at least a portion of the second chamber may for example be carried out by means of an electrohydraulic servo valve and/or a pump for the working medium. The control valve may for example comprise or be constituted by a solenoid operated directional control valve and/or a hydraulic operated directional control valve.

According to one example, for each or any pressure intensifier unit, the body may for example comprise or be constituted by a piston unit. For each or any pressure intensifier unit, the second chamber may for example comprise or be constituted by a piston unit chamber. For each or any pressure intensifier unit, the actuating mechanism may for example comprise a source and a sink of hydraulic fluid in fluid communication with the piston unit chamber via a control valve. The control valve may be configured to cause movement of the piston unit within the piston unit chamber, and possibly control the direction of the movement of the piston unit within the piston unit chamber, by controllably supplying at least a portion of the piston unit chamber with hydraulic medium and draining hydraulic medium from at least a portion of the piston unit chamber. It is however to be understood that such realization or implementation of the pressure intensifier unit(s) is according to an example, and that other ways of realizing or implementing the pressure intensifier unit(s) are possible.

As described in the foregoing, for each pressure intensifier unit, the actuating mechanism may be controlled to move the body repeatedly back and forth between the first end position and the second end position while adjusting the speed for attaining a selected speed. Possibly, the selected speed may be the same for all pressure intensifier units. The said controlling of the actuating mechanism for each pressure intensifier unit (which controlling is included in the pressure increasing phase) to move the body repeatedly back and forth between the first end position and the second end position while adjusting the speed for attaining a selected speed may be carried out simultaneously for each pressure intensifier unit.

For each or any of the pressure intensifier units, the controllable supplying of at least a portion of the second chamber with working medium and draining of working medium from at least a portion of the second chamber may for example be carried out by means of a pump for the working medium. A motor may be used to drive the pump. The motor may for example be a frequency-controlled motor. The motor may be adjustable so as to allow for adjusting the speed with which the at least a portion of the second chamber with working medium is supplied with working medium and the speed with which the at least a portion of the second chamber is drained from working medium. Thus, for each or any of the pressure intensifier units, by adjusting the (operation of the) motor, the body can be controllably moved back and forth between the first end position and the second end position while adjusting the speed for attaining a selected speed. Each pressure intensifier unit may be controlled individually. For example, there may be a separate pump for the working medium for each pressure intensifier unit, and possibly also a separate motor for each pressure intensifier unit for driving the corresponding pump for the working medium. However, it is possible for one motor to drive the pumps for the working medium for several pressure intensifier units.

In the context of the present application, by a speed of movement of the body of a pressure intensifier, it may be meant not an instantaneous speed of the body, but an average speed of the body during its movement between the first end position and the second end position, possibly taken over a period of time during which the body moves back and forth between the first end position and the second end position several times. Possibly, the speed of movement of the body of a pressure intensifier may refer to the number of times the body moves back and forth between the first end position and the second end position per unit time, i.e., the frequency of the back-and-forth movement of the body. For each or any of the pressure intensifier units, the body can for example be controllably moved back and forth between the first end position and the second end position while adjusting an average speed of the body during its movement between the first end position and the second end position, as mentioned above, for attaining a selected speed, or while adjusting the frequency of the back-and-forth movement of the body, as also mentioned above, for attaining the selected speed. Thus, instead of a speed of movement of the body of a pressure intensifier, it could for example be referred to an average speed of movement of the body of a pressure intensifier, or to a frequency of the back-and-forth movement of the body of a pressure intensifier, without any loss of generality.

The said controlling of the actuating mechanisms of the pressure intensifier units such that each of the bodies has a selected position in the corresponding second chamber in relation to the position(s) of the other body or bodies in its or their corresponding second chamber(s) may for example comprise controlling the actuating mechanisms of the pressure intensifier units based on the position of the body of a selected one of the pressure intensifier units such that the other body or bodies have selected positions in their respective second chambers in relation to the position of the body of the selected one of the pressure intensifier units. The selected one of the pressure intensifier units may for example be or have been selected based on measurement data indicative of pressure medium feeding capacity of the pressure intensifiers unit obtained based on, or from, a previous pressure increasing phase.

The selected one of the pressure intensifier units may possibly be referred to as a “master” pressure intensifier unit, in the sense that all other pressure intensifier units are controlled in relation to the selected one of the pressure intensifier units.

The measurement data may have been obtained based on or from a previous pressure increasing phase by measurements carried out during the previous pressure increasing phase.

For example, the selected one of the pressure intensifier units may be or have been selected based on measurement data indicative of which of the pressure intensifier units that has a lowest pressure medium feeding capacity. The selected one of the pressure intensifier units may be or have been selected as the one of the pressure intensifier units or as one of the pressure intensifier units having the lowest pressure medium feeding capacity.

For each or any of the pressure intensifier units and during a pressure increasing phase, a pressure medium feeding capacity of the pressure intensifier unit may be controlled in dependence on the pressure that has been attained in the pressure vessel. For example, for each or any of the pressure intensifier units and during a pressure increasing phase, the larger the pressure that has been attained in the pressure vessel, the lower the pressure medium feeding capacity of the pressure intensifier unit may be.

For each or any of the pressure intensifier units, a pressure medium feeding capacity of the pressure intensifier unit may be governed by the speed at which the body can be moved back and forth between the first end position and the second end position. As mentioned, the speed is adjustable, and for each or any of the pressure intensifier units, the actuating mechanism may be controlled to move the body repeatedly back and forth between the first end position and the second end position while adjusting the speed for attaining a selected speed. However, while during said controlling of the actuating mechanisms, selected speeds of the pressure intensifier units are trying to be attained, the actual speeds that can actually be attained by said controlling of the actuating mechanisms may differ somewhat from the respective selected speeds. A reason for this may be due to any changes in frictional resistance in the pressure intensifier units, e.g., in sealings, which may be caused by heat and/or pressure to which the pressure intensifier units may be subjected. Another reason may be any internal leakage in the pressure intensifier units and/or in any means for supplying or extracting a working medium to or from the pressure intensifier units. Such means could for example comprise a hydraulic mechanism which, for each or any of the pressure intensifier units, may be configured to cause movement of the body within the second chamber and possibly control the direction of the movement of the body within the second chamber by controllably supplying at least a portion of the second chamber with hydraulic medium and draining hydraulic medium from at least a portion of the second chamber. The capacity of such supplying and draining of working medium (e.g., hydraulic medium) may change due to any internal leakage in the pressure intensifier units and/or in any means for supplying or extracting a working medium from the pressure intensifier units. The risk of such internal leakage may become higher the higher the pressure to which the pressure intensifier units are subjected. Yet another reason could be wear of components of the pressure intensifier units. Other reasons are possible.

As indicated in the foregoing, during a (or the) pressure increasing phase, for each or any of the pressure intensifier units, the actuating mechanism may be controlled to move the body repeatedly back and forth between the first end position and the second end position while adjusting the speed for attaining a selected speed. For each or any of the pressure intensifier units, the selected speed may be changed during the pressure increasing phase, to thereby adjust or control a pressure medium feeding capacity of the pressure intensifier unit, which for example may be done in dependence on the pressure that has been attained in the pressure vessel. Thus, the selected speed for each or any of the pressure intensifier units may be non-constant during the pressure increasing phase. For example, the larger the pressure becomes in the pressure vessel during the pressure increasing phase (e.g., as a result of the pressure increase in the pressure vessel occurring during the pressure increasing phase), the smaller the selected speed for each or any of the pressure intensifier units may be.

As mentioned, the selected one of the pressure intensifier units may be referred to as a “master” pressure intensifier unit, in the sense that all other pressure intensifier units are controlled in relation to the selected one of the pressure intensifier units.

The said controlling of the actuating mechanisms of the pressure intensifier units based on the position of the body of the selected one of the pressure intensifier units such that the other body or bodies have selected positions in their respective second chambers in relation to the position of the body of the selected one of the pressure intensifier units may be done in different ways. For each pressure intensifier unit, the actuating mechanism may be controllable with respect to the direction of movement of the body along the path. The said controlling of the actuating mechanisms of the pressure intensifier units based on the position of the body of the selected one of the pressure intensifier units such that the other body or bodies have selected positions in their respective second chambers in relation to the position of the body of the selected one of the pressure intensifier units, may for example include one or more of the following actions i), ii), iii) and iv), for each pressure intensifier unit other than the selected one of the pressure intensifier units:
i) controlling of the actuating mechanism of the pressure intensifier unit to momentarily hold, or delay, the body so as to attain the selected position in relation to the position of the body of the selected one of the pressure intensifier units, ii) controlling of the actuating mechanism of the pressure intensifier unit to momentarily decrease speed of the movement of the body so as to attain the selected position in relation to the position of the body of the selected one of the pressure intensifier units, iii) controlling of the actuating mechanism of the pressure intensifier unit to momentarily increase speed of the movement of the body so as to attain the selected position in relation to the position of the body of the selected one of the pressure intensifier units, and iv) controlling of the actuating mechanism of the pressure intensifier unit to change the direction of the movement of the body for attaining the selected position in relation to the position of the body of the selected one of the pressure intensifier units.

Holding or delaying in accordance with the above-mentioned action i) may in at least some cases be for a time between about 1 ms and 100 ms, particularly in case the pressure intensifier unit is configured in accordance with a linear pressure intensifier. In case the pressure intensifier unit would be configured in accordance with a combination of different types of pressure intensifiers, the holding or delaying in accordance with the above-mentioned action i) may be for a time longer than 100 ms.

The momentarily holding, or delaying, of a body may for example be carried out when the body has reached first end position or the second end position.

In order to achieve that the other body or bodies have selected positions in their respective second chambers in relation to the position of the body of the selected one of the pressure intensifier units, the said controlling of the actuating mechanisms of the pressure intensifier units may need to carried out during an extended period of time during which the bodies of the respective pressure intensifier units are moved between the first and second end positions multiple times while one or more of the above-mentioned actions i), ii), iii) and iv) are carried out. For example, for each or any of the pressure intensifier units, any of the above-mentioned actions i), ii) and iii) may be carried out at least once during each time the body moves from the first end position to the second end position, or vice versa (which may be referred to as a single stroke), or at least once during each time the body moves from the first end position to the second end position and back to the first end position, or vice versa (which may be referred to as a double stroke).

As mentioned, there may be provided means for supplying or extracting a working medium from the pressure intensifier units. For each pressure intensifier unit, such means could for example comprise a source and a sink of working medium (e.g., hydraulic fluid) in fluid communication with the second chamber via a control valve. The control valve may be configured to cause movement of the body within the second chamber, and possibly control the direction of the movement of the body within the second chamber, by controllably supplying at least a portion of the second chamber with working medium and draining working medium from at least a portion of the second chamber. The controllable supplying of at least a portion of the second chamber with working medium and draining of working medium from at least a portion of the second chamber may for example be carried out by means of an electrohydraulic servo valve and/or a pump for the working medium. The control valve may for example comprise or be constituted by a solenoid operated directional control valve and/or a hydraulic operated directional control valve.

Any combination of at least two of the above-mentioned actions i)-iv) may be employed. For example, the said controlling of the actuating mechanisms of the pressure intensifier units based on the position of the body of the selected one of the pressure intensifier units such that the other body or bodies have selected positions in their respective second chambers in relation to the position of the body of the selected one of the pressure intensifier units may be done by, for each pressure intensifier unit other than the selected one of the pressure intensifier units, controlling of the actuating mechanism of the pressure intensifier unit to momentarily hold, or delay, the body for a certain time followed by changing the direction of the movement of the body for attaining the selected position in relation to the position of the body of the selected one of the pressure intensifier units.

As mentioned, for each or any of the pressure intensifier units, a pressure medium feeding capacity of the pressure intensifier unit may be governed by the speed at which the body can be moved back and forth between the first end position and the second end position. The speed at which the body is moved back and forth between the first end position and the second end position can be determined by means of determining a mean time required for the body to move between the first end position and the second end position (and knowledge of the length of the path along which the body moves within the second chamber back and forth between a first end position and a second end position). The selected one of the pressure intensifier units may be the pressure intensifier unit having a largest mean time (or in other words, the pressure intensifier unit which is “slowest”).

To that end, the system may comprise at least one sensor, which may be configured to, for each pressure intensifier unit, sense position of the body directly or indirectly. For example, there could be provided one sensor for each pressure intensifier unit, and for each pressure intensifier unit, the corresponding sensor may be configured to sense position of the body of the pressure intensifier unit. A sensor that may sense position of the body indirectly may for example monitor the pressure of the hydraulic mechanism or driving hydraulic to sense a pressure spike when the body (e.g., a piston) hits or reaches its end position(s). The at least one sensor may be configured to, for each pressure intensifier unit, sense position of the body continuously (e.g., over the whole path). The at least one sensor may be configured to, for each pressure intensifier unit, (e.g., only) sense when the body is in the first end position or in the second end position.

The at least one control and/or processing unit may be configured to, prior to said pressure increasing phase, for each pressure intensifier unit, control the actuating mechanism to move the body repeatedly back and forth between the first end position and the second end position during a selected period of time, and obtain values indicative of the position of the body during the selected period of time at a plurality of time instants from the at least one sensor. The at least one control and/or processing unit may be configured to, based on the obtained values, determine a mean time required for the body to move between the first end position and the second end position. The at least one control and/or processing unit may be configured to, prior to said pressure increasing phase, compare the mean times determined for the respective ones of the pressure intensifier units to determine a largest mean time, and control the actuating mechanisms of the pressure intensifier units based on the position of the body of the pressure intensifier unit(s) for which the determined mean time equals the largest mean time such that the other body or bodies have selected positions in relation to the position of the body of the pressure intensifier unit(s) for which the determined mean time equals the largest mean time. Subsequently, said pressure increasing phase may be carried out. Thus, the selected one of the pressure intensifier units may be a pressure intensifier unit having a largest mean time, which pressure intensifier unit may be referred to as a “master” pressure intensifier unit in the sense that all other pressure intensifier units are controlled in relation to that pressure intensifier unit.

During said pressure increasing phase it may occur that the pressure intensifier unit previously selected as the “master” pressure intensifier unit, due to it having the largest mean time, may not anymore have the largest mean time, but another one of the pressure intensifier units may instead have the largest mean time. This may occur for example due to any changes in frictional resistance in the pressure intensifier units, e.g., in sealings, which may be caused by heat and/or pressure to which the pressure intensifier units may be subjected during the pressure increasing phase, or due to any internal leakage in the pressure intensifier units and/or in any means for supplying or extracting a working medium from the pressure intensifier units that may occur during the pressure increasing phase.

Therefore, during the pressure increasing phase it may be checked whether the pressure intensifier unit previously selected as the “master” pressure intensifier unit is still to be considered to be the “master” pressure intensifier unit, and if not, a new “master” pressure intensifier unit may be determined and applied, e.g., for at least a portion of the remainder of the pressure increasing phase. Such a check may be carried out repeatedly during the pressure increasing phase, e.g., continuously or continually, or at predefined time intervals.

To that end, the at least one control and/or processing unit may for example be configured to, during said pressure increasing phase and for each pressure intensifier unit, obtain values indicative of the position of the body during a selected period of time at a plurality of time instants from the at least one sensor, and based on the obtained values, determine a mean time required for the body to move between the first end position and the second end position. The at least one control and/or processing unit may further be configured to compare the mean times determined for the respective ones of the pressure intensifier units to determine a largest mean time, and control the actuating mechanisms of the pressure intensifier units based on the position of the body of the pressure intensifier unit(s) for which the determined mean time equals the largest mean time (which pressure intensifier hence may be considered as the new “master” pressure intensifier unit) such that the other body or bodies have selected positions in relation to the position of the body of the pressure intensifier unit(s) for which the determined mean time equals the largest mean time, and, subsequently, control the actuating mechanism to move the body repeatedly back and forth between the first end position and the second end position while adjusting the speed for attaining a selected speed, thereby repeatedly forcing pressure medium in the first chamber(s) to the outlet to exit the pressure intensifier unit and to be fed into the pressure vessel. The selected positions of the other body or bodies and/or the selected speed for each pressure intensifier unit may be such that during at least a portion of time, the bodies of at least some of the pressure intensifier units are in the first end position and in the second end position at different points in time and/or the speed is the same for at least some of the pressure intensifier units.

As mentioned, for each or any pressure intensifier unit, the body may for example comprise or be constituted by a piston unit, or piston. The mean time required for the body to move between the first end position and the second end position may be a mean stroke time of the piston unit or piston.

The said controlling of the actuating mechanisms of the pressure intensifier units based on the position of the body of the pressure intensifier unit(s) for which the determined mean time equals the largest mean time such that the other body or bodies have selected positions in relation to the position of the body of the pressure intensifier unit(s) for which the determined mean time equals the largest mean time may be done in different ways.

For each pressure intensifier unit, the actuating mechanism may be controllable with respect to the direction of movement of the body along the path. The controlling of the actuating mechanisms of the pressure intensifier units based on the position of the body of the pressure intensifier unit(s) for which the determined mean time equals the largest mean time such that the other body or bodies have selected positions in relation to the position of the body of the pressure intensifier unit(s) for which the determined mean time equals the largest mean time may comprise, for each pressure intensifier unit other than the pressure intensifier unit(s) for which the determined mean time equals the largest mean time, one or more of the following actions A), B), C) and D):
A) controlling of the actuating mechanism of the pressure intensifier unit to momentarily hold the body so as to attain the selected position in relation to the position of the body in the pressure intensifier unit(s) for which the determined mean time equals the largest mean time, B) controlling of the actuating mechanism of the pressure intensifier unit to momentarily decrease speed of the movement of the body so as to attain the selected position in relation to the position of the body in the pressure intensifier unit(s) for which the determined mean time equals the largest mean time, C) controlling of the actuating mechanism of the pressure intensifier unit to momentarily increase speed of the movement of the body so as to attain the selected position in relation to the position of the body in the pressure intensifier unit(s) for which the determined mean time equals the largest mean time, and D) controlling of the actuating mechanism of the pressure intensifier unit to change the direction of the movement of the body for attaining the selected position in relation to the position of the body in the pressure intensifier unit(s) for which the determined mean time equals the largest mean time.

Holding or delaying in accordance with the above-mentioned action A) may in at least some cases be for a time between about 1 ms and 100 ms, particularly in case the pressure intensifier unit is configured in accordance with a linear pressure intensifier. In case the pressure intensifier unit would be configured in accordance with a combination of different types of pressure intensifiers, the holding or delaying in accordance with the above-mentioned action A) may be for a time longer than 100 ms.

The momentarily holding, or delaying, of a body may for example be carried out once the body has reached first end position or the second end position.

In order to achieve that the other body or bodies have selected positions in relation to the position of the body of the pressure intensifier unit(s) for which the determined mean time equals the largest mean time, the said controlling of the actuating mechanisms of the pressure intensifier units may need to be carried out during an extended period of time during which the bodies of the respective pressure intensifier units are moved between the first and second end positions multiple times while one or more of the above-mentioned actions A), B), C) and D) are carried out. For example, for each or any of the pressure intensifier units, any of the above-mentioned actions A), B) and C) may be carried out at least once during each time the body moves from the first end position to the second end position, or vice versa (which may be referred to as a single stroke), or at least once during each time the body moves from the first end position to the second end position and back to the first end position, or vice versa (which may be referred to as a double stroke).

As mentioned, there may be provided means for supplying or extracting a working medium from the pressure intensifier units. For each pressure intensifier unit, such means could for example comprise a source and a sink of working medium (e.g., hydraulic fluid) in fluid communication with the second chamber via a control valve. The control valve may be configured to cause movement of the body within the second chamber, and possibly control the direction of the movement of the body within the second chamber, by controllably supplying at least a portion of the second chamber with working medium and draining working medium from at least a portion of the second chamber. The controllable supplying of at least a portion of the second chamber with working medium and draining of working medium from at least a portion of the second chamber may for example be carried out by means of an electrohydraulic servo valve and/or a pump for the working medium. The control valve may for example comprise or be constituted by a solenoid operated directional control valve and/or a hydraulic operated directional control valve.

Any combination of at least two of the above-mentioned actions A)-D) may be employed. For example, the said controlling of the actuating mechanisms of the pressure intensifier units based on the position of the body of the pressure intensifier unit(s) for which the determined mean time equals the largest mean time such that the other body or bodies have selected positions in relation to the position of the body of the pressure intensifier unit(s) for which the determined mean time equals the largest mean time may be done by, for each pressure intensifier unit other than the pressure intensifier unit(s) for which the determined mean time equals the largest mean time, controlling of the actuating mechanism of the pressure intensifier unit to momentarily hold, or delay, the body for a certain time followed by changing the direction of the movement of the body for attaining the selected position in relation to the position of the body of the selected one of the pressure intensifier units.

As described in the foregoing, prior to carrying out a pressure increasing phase, the actuating mechanisms of the pressure intensifier units may be controlled based on the position of the body of a selected one of the pressure intensifier units such that the other body or bodies have selected positions in their respective second chambers in relation to the position of the body of the selected one of the pressure intensifier units. The selected one of the pressure intensifier units may possibly be determined based on information that may have been gathered or collected during a previous pressure increasing phase, e.g., by means of artificial intelligence techniques.

According to one example in accordance with such an approach, the at least one control and/or processing unit may be configured to, during a pressure increasing phase (e.g., the pressure increasing phase referred to with respect to the first aspect of the present invention as described in the foregoing) and for each pressure intensifier unit, obtain values indicative of the position of the body during a selected period of time at a plurality of time instants from the at least one sensor (which, as described in the foregoing, may be configured to, for each pressure intensifier unit, sense position of the body), and, based on the obtained values, determine a plurality of mean times required for the body to move between the first end position and the second end position, the plurality of mean times corresponding to the respective ones of the different periods of time during said pressure increasing phase. The at least one control and/or processing unit may be further configured to compare the mean times determined for the respective ones of the pressure intensifier units to determine a pressure intensifier unit of the plurality of pressure intensifier units for which the mean time required for the body to move between the first end position and the second end position most often during said pressure increasing phase is the largest. The at least one control and/or processing unit may be further configured to control the actuating mechanisms of the pressure intensifier units based on the position of the body of the determined pressure intensifier unit such that the other body or bodies have selected positions in their respective second chambers in relation to the position of the body of the determined pressure intensifier unit, and subsequently carry out another pressure increasing phase, comprising controlling the actuating mechanism to move the body repeatedly back and forth between the first end position and the second end position while adjusting the speed for attaining a selected speed, thereby repeatedly forcing pressure medium in the first chamber(s) to the outlet to exit the pressure intensifier unit and to be fed into the pressure vessel, and wherein the selected positions of the other body or bodies and/or the selected speed for each pressure intensifier unit are such that during at least a portion of the other pressure increasing phase, the bodies of at least some of the pressure intensifier units are in the first end position and in the second end position at different points in time and/or the speed is the same for at least some of the pressure intensifier units.

Thus, according to the above-described approach, information for each pressure intensifier unit regarding mean times required for the body to move between the first end position and the second end position corresponding to the different periods of time during said pressure increasing phase may be gathered or collected during said pressure increasing phase, and that information may then be used to determine a pressure intensifier unit that should be the “master” pressure intensifier unit in another, subsequent pressure increasing phase.

As mentioned, the fact that during pressure increasing phase one of the pressure intensifier units of the plurality of pressure intensifier units may have a largest mean time required for the pressure intensifier's body to move between the first end position and the second end position may for example be due to any changes in frictional resistance in the pressure intensifier units or any internal leakage in the pressure intensifier units and/or in any means for supplying or extracting a working medium from the pressure intensifier units that may occur during the pressure increasing phase. However, other factors may (e.g., in addition) govern which one of the plurality of pressure intensifier units that, at a certain time instant during the pressure increasing phase or during a certain part of the pressure increasing phase, has the largest mean time required for the pressure intensifier's body to move between the first end position and the second end position. Such other factors may include the pressure level in the pressure vessel at the said time instant or during the said part of the pressure increasing phase.

The at least one control and/or processing unit may for example include or be constituted by one or more of any suitable central processing unit (CPU), microcontroller, programmable logic controller (PLC), digital signal processor (DSP), Application Specific Integrated Circuit (ASIC), Field Programmable Gate Array (FPGA), etc., or any combination thereof. The at least one control and/or processing unit may optionally be capable of executing software instructions stored in a computer program product, e.g., in the form of a memory. The memory may for example be any combination of read and write memory (RAM) and read only memory (ROM). The memory may comprise persistent storage, which for example can be a magnetic memory, an optical memory, a solid state memory or a remotely mounted memory, or any combination thereof.

According to a third aspect of the present invention, a computer program is provided. The computer program comprises instructions, which when executed by one or more processors comprised in at least one control and/or processing unit in a system according to the first aspect of the present invention, cause the at least one control and/or processing unit to perform a method according to the second aspect of the present invention.

According to a fourth aspect of the present invention, a processor-readable medium is provided. The processor-readable medium has a computer program loaded thereon, wherein the computer program comprises instructions, which when executed by one or more processors comprised in at least one control and/or processing unit in a system according to the first aspect of the present invention, cause the at least one control and/or processing unit to perform a method according to the second aspect of the present invention.

Each or any of the one or more processors may for example comprise a CPU, a microcontroller, a PLC, a DSP, an ASIC, an FPGA, etc., or any combination thereof. The processor-readable medium may for example include a Digital Versatile Disc (DVD) or a floppy disk or any other suitable type of processor-readable means or processor-readable (digital) medium, such as, but not limited to, a memory such as, for example, non-volatile memory, a hard disk drive, a Compact Disc (CD), a Flash memory, magnetic tape, a Universal Serial Bus (USB) memory device, a Zip drive, etc.

According to a sixth aspect of the present invention, a press apparatus is provided. The press apparatus comprises a pressure vessel, a pressure medium source and a system according to the first aspect of the present invention. The pressure medium source is configured to be selectively in fluid communication with the pressure vessel via the pressure intensifier units of the system such that pressure medium can be transported from the pressure medium source to the pressure vessel via the pressure intensifier units. Each pressure intensifier unit is configured to receive pressure medium at the inlet of the pressure intensifier unit from the pressure medium source and increase the pressure in the pressure vessel by feeding pressure medium into the pressure vessel. For each pressure intensifier unit, the at least one first chamber of the pressure intensifier unit is configured to continuously or continually receive the pressure medium having been received at the inlet of the pressure intensifier unit from the pressure medium source.

The press apparatus may for example comprise or be constituted by an isostatic press apparatus, which may be configured to treat at least one article when placed in the pressure vessel by means of isostatic pressing, such as CIP, WIP or HIP.

Further objects and advantages of the present invention are described in the following by means of exemplifying embodiments. It is noted that the present invention relates to all possible combinations of features recited in the claims. Further features of, and advantages with, the present invention will become apparent when studying the appended claims and the description herein. Those skilled in the art realize that different features of the present invention can be combined to create embodiments other than those described herein.

### BRIEF DESCRIPTION OF THE DRAWINGS

Exemplifying embodiments of the present invention will be described below with reference to the accompanying drawings.

FIG. 1 is a schematic view of a press apparatus according to an embodiment of the present invention.

FIG. 2 is a schematic view of a portion of a press apparatus according to an embodiment of the present invention.

FIG. 3 is a schematic flowchart illustrating a method according to an embodiment of the present invention.

FIG. 4 is a schematic view of a press apparatus according to an embodiment of the present invention.

The figures are schematic, not necessarily to scale, and generally only show parts which are necessary in order to elucidate embodiments of the present invention, wherein other parts may be omitted or merely suggested.

### DESCRIPTION WITH REFERENCE TO THE DRAWINGS

The present invention will now be described hereinafter with reference to the accompanying drawings, in which exemplifying embodiments of the present invention are illustrated. The present invention may, however, be embodied in many different forms and should not be construed as limited to the embodiments of the present invention set forth herein; rather, these embodiments are provided by way of example so that this disclosure will convey the scope of the present invention to those skilled in the art.

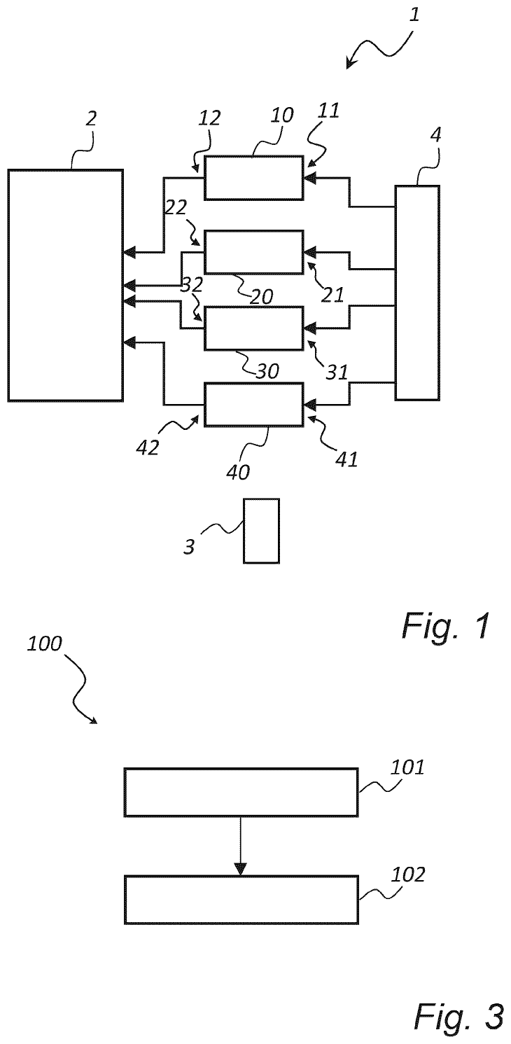

FIG. 1 is a schematic view of a press apparatus 1 according to an embodiment of the present invention. The press apparatus 1 comprises a pressure vessel 2, a pressure medium source 4 and a system including components indicated by reference numerals 3, 10, 20, 30, 40 and which will be described further in the following.

The pressure vessel 2 is for holding pressure medium. The press apparatus 1 may for example comprise or be constituted by an isostatic press apparatus, which may be configured to treat at least one article (not shown in FIG. 1) when placed in the pressure vessel 2 by means of isostatic pressing, such as cold isostatic pressing (CIP), warm isostatic pressing (WIP) or hot isostatic pressing (HIP).

The system comprises a plurality of pressure intensifier units 10, 20, 30, 40. Each pressure intensifier unit 10, 20, 30, 40 is configured to increase the pressure in the pressure vessel 2 by feeding pressure medium into the pressure vessel 2. It is to be understood that the number of pressure intensifier units illustrated in FIG. 1, i.e., four, is according to an example, and that the system could in principle include any number of pressure intensifier units, such as two, three, five, six, eight, ten, twelve or fifteen or more.

The pressure medium source 4 is configured to be selectively in fluid communication with the pressure vessel 2 via the pressure intensifier units 10, 20, 30, 40 such that pressure medium can be transported from the pressure medium source 4 to the pressure vessel 2 via the pressure intensifier units 10, 20, 30, 40.

Each pressure intensifier unit 10, 20, 30, 40 is configured to receive pressure medium at a respective inlet 11, 21, 31, 41 of the pressure intensifier unit 10, 20, 30, 40 from the pressure medium source 4 and increase the pressure in the pressure vessel 2 by feeding pressure medium into the pressure vessel 2. Each pressure intensifier unit 10, 20, 30, 40 is configured to output pressure medium at a respective outlet 12, 22, 32, 42 of the pressure intensifier unit 10, 20, 30, 40.

Each of the inlets 11, 21, 31, 41 of the respective pressure intensifier units 10, 20, 30, 40 is configured to continuously or continually receive pressure medium, e.g., from the pressure medium source 4. Each of the outlets 12, 22, 32, 42 of the respective is configured to be connected to the pressure vessel 2 for feeding pressure medium thereto.

In FIG. 1, the lines with arrows represent pressure medium guiding passages, including, e.g., conduits, piping, etc., for guiding pressure medium, and the arrows denote the direction of flow in the pressure medium guiding passages.

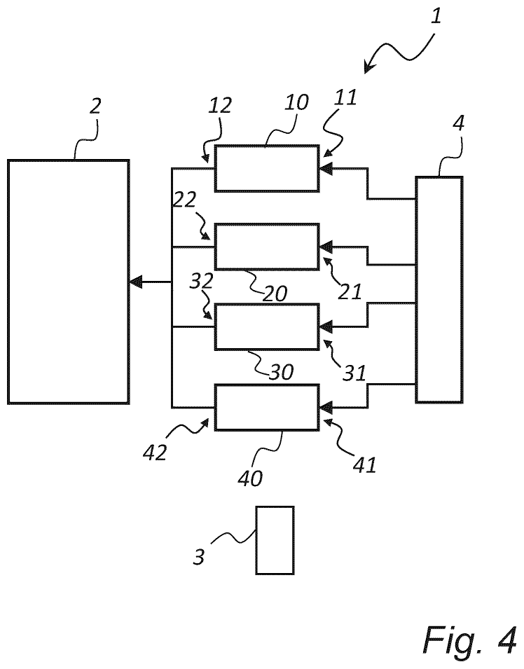

While FIG. 1 suggests that each pressure intensifier units 10, 20, 30, 40 is connected to a separate inlet of the pressure vessel 2, this is not required. For example, all of the pressure intensifier units 10, 20, 30, 40 could be connected to a same inlet of the pressure vessel 2, for example such as illustrated in FIG. 4. FIG. 4 is a schematic view of a press apparatus 1 according to an embodiment of the present invention. The press apparatus 1 illustrated in FIG. 4 is configured in the same way as the press apparatus 1 illustrated in FIG. 1 except for that the pressure intensifier units 10, 20, 30, 40 are connected to a same inlet of the pressure vessel 2. As illustrated in FIG. 4, pressure medium guiding passages from each the pressure intensifier units 10, 20, 30, 40 may be joined into a single pressure medium guiding passage that is coupled to the pressure vessel 2. Technical advantages related to embodiments of the present invention as described in the foregoing may be more pronounced in situations such as illustrated in FIG. 4, wherein for M pressure intensifier units there are pressure medium guiding passages from each the pressure intensifier units and two or more of the pressure medium guiding passages are joined such that the flow from the pressure intensifier units enter the pressure vessel 2 via N pressure medium guiding passages that are coupled to the pressure vessel 2, where N and M are positive integers and N<M, M≥2 and N≥1. FIG. 4 illustrates a case where M=4 and N=1. However, according to other embodiments of the present invention, N≤M. Such an embodiment of the present invention is the one illustrated in FIG. 1 for which M=N=4.

While FIGS. 1 and 4 suggest that each pressure intensifier units 10, 20, 30, 40 is connected to the pressure medium source 4 via separate pressure medium guiding passages, this not required. For example, a single pressure medium guiding passage could at one end be connected to the pressure medium source 4 and at the other end split into four pressure medium guiding passages each being connected to a corresponding one of the pressure intensifier units 10, 20, 30, 40.

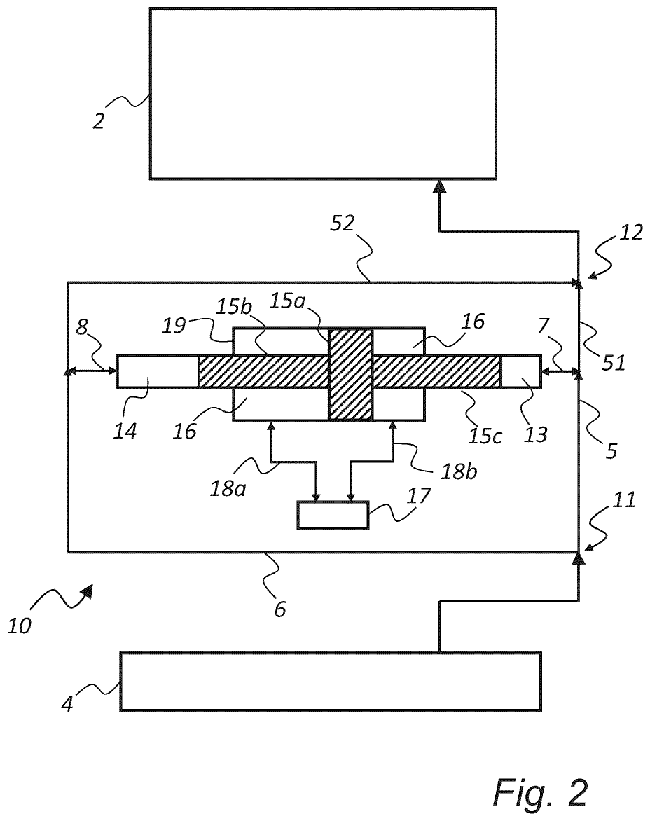

As will be described in more detail in the following with reference to FIG. 2, each pressure intensifier unit 10, 20, 30, 40 comprises at least one first chamber in fluid communication with the inlet 11, 21, 31, 41 and the outlet 12, 22, 32, 42, respectively, and configured to continuously or continually receive the pressure medium having been received at the inlet 11, 21, 31, 41. Further, each pressure intensifier unit 10, 20, 30, 40 comprises a body that is controllably movable within a second chamber along a path back and forth between a first end position and a second end position. Further, each pressure intensifier unit 10, 20, 30, 40 comprises an actuating mechanism configured to controllably move the body back and forth between the first end position and the second end position at an adjustable speed and being controllable at least with respect to positioning of the body along the path. For each pressure intensifier unit 10, 20, 30, 40, the at least one first chamber, the body and the second chamber are arranged such that by movement of the body at least once between the first end position and the second end position, any pressure medium in the first chamber(s) is forced to the outlet 12, 22, 32, 42 to exit the pressure intensifier unit 10, 20, 30, 40.

The system comprises at least one control and/or processing unit. In accordance with the embodiment of the present invention illustrated in FIG. 1, the system comprises one control and/or processing unit 3.

The control and/or processing unit 3 is configured to control operation of the pressure intensifier units 10, 20, 30, 40, and particularly to control the actuating mechanisms of the pressure intensifier units 10, 20, 30, 40. To that end, the control and/or processing unit 3 may be connected to the pressure intensifier units 10, 20, 30, 40, for example to each of the pressure intensifier units 10, 20, 30, 40 individually. Such connection may be implemented or realized by any wireless and/or wired means for example such as known in the art. Such connection may be a communicative connection, such that the at least one control and/or processing unit 3 may be able to communicate with the pressure intensifier units 10, 20, 30, 40 and/or any other component in the system 3, 10, 20, 30, 40 or in the press apparatus 1 via wired and/or wireless communication means or techniques, for example via any appropriate wired and/or wireless communication means or techniques as known in the art, for transmitting messages, instructions, data, commands, etc., from the at least one control and/or processing unit 3 to the pressure intensifier units 10, 20, 30, 40 and/or any other component in the system 3, 10, 20, 30, 40 or in the press apparatus 1 and possibly vice versa. The control and/or processing unit 3 may be configured to control operation of the pressure intensifier units 10, 20, 30, 40 individually, and may in particular be configured to control the actuating mechanisms of the pressure intensifier units 10, 20, 30, 40 individually.

The control and/or processing unit 3 is configured to control the actuating mechanisms of the pressure intensifier units 10, 20, 30, 40 such that each of the bodies has a selected position in the corresponding second chamber in relation to the position(s) of the other body or bodies in its or their corresponding second chamber(s), and, subsequently, carry out a pressure increasing phase. The pressure increasing phase comprises, for each pressure intensifier unit 10, 20, 30, 40, controlling the actuating mechanism to move the body repeatedly back and forth between the first end position and the second end position while adjusting the speed for attaining a selected speed, thereby repeatedly forcing pressure medium in the first chamber(s) to the outlet 12, 22, 32, 42 to exit the pressure intensifier unit 10, 20, 30, 40 and to be fed into the pressure vessel 2, and wherein the selected positions of the bodies and/or the selected speed for each pressure intensifier unit 10, 20, 30, 40 are such that during at least a portion of the pressure increasing phase, the bodies of at least some, possibly all, of the pressure intensifier units 10, 20, 30, 40 are in the first end position and in the second end position at different points in time and/or the speed is the same for at least some, possibly all, of the pressure intensifier units 10, 20, 30, 40.

FIG. 2 is a schematic view of a portion of a press apparatus 1 according to an embodiment of the present invention. It is to be understood that FIG. 2 is very schematic and intended to illustrate working principles of one or more embodiments of the present invention. The press apparatus illustrated in FIG. 2 is similar to the press apparatus 1 illustrated in FIG. 1. However, in FIG. 2 only one of the pressure intensifier units—the pressure intensifier unit 10—is illustrated, while the other pressure intensifiers are not shown in FIG. 2. FIG. 2 illustrates the pressure intensifier unit 10 in greater detail than in FIG. 1. It is to be understood that any other pressure intensifier unit which may be included in the press apparatus 1, such as, for example, each or any of the pressure intensifier units 20, 30, 40 illustrated in FIG. 1, may be configured similarly to or the same as the pressure intensifier unit 10 illustrated in FIG. 2.

As illustrated in FIG. 2, the pressure intensifier unit 10 comprises an inlet 11 configured to continuously or continually receive pressure medium from the pressure medium source 4, and an outlet 12 configured to be connected to the pressure vessel 2 for feeding pressure medium thereto.

The pressure intensifier unit 10 comprises two first chambers 13, 14 which are in fluid communication with the inlet 11 and the outlet 12, respectively. The first chambers 13, 14 are configured to continuously or continually receive the pressure medium having been received at the inlet 11.

In FIG. 2, most of the lines with arrows represent pressure medium guiding passages, including, e.g., conduits, piping, etc., for guiding pressure medium, and the arrows denote the direction of flow in the pressure medium guiding passages. The first chambers 13, 14 are configured to continuously or continually receive the pressure medium having been received at the inlet 11 by means of pressure medium guiding passages 5, 6, 7 and 8.

The pressure intensifier unit 10 comprises a body 15a, 15b, 15c, which is controllably movable within a second chamber 16 along a path back and forth between a first end position and a second end position. In accordance with the embodiment of the present invention illustrated in FIG. 2, the pressure intensifier unit 10 comprises a housing 19, e.g., including or being constituted by a cylinder, and the body 15a, 15b, 15c is axially displaceable within the housing 19 along a longitudinal or central axis of the housing 19.

Further in accordance with the embodiment of the present invention illustrated in FIG. 2, the first end position may be defined as the position the body 15a, 15b, 15c has in the second chamber 16 when the body 15a, 15b, 15c has moved as far to the left in the figure as it is able to, and the second end position may be defined as the position the body 15a, 15b, 15c has in the second chamber 16 when the body has moved as far to the right in the figure as it is able to.

It is to be understood that even though the body 15a, 15b, 15c is illustrated in FIG. 2 as being composed of different parts which have been attached to each other, the body 15a, 15b, 15c may be formed as a single component or part.

As indicated in FIG. 2, the body 15a, 15b, 15c may be sized or dimensioned in relation to the interior of the housing 19 such that when body 15a, 15b, 15c moves within the second chamber 16 along a path back and forth between the first end position and the second end position, the body 15a, 15b, 15c slides over an inner surface of the housing 19.

The pressure intensifier unit 10 comprises an actuating mechanism configured to controllably move the body 15a, 15b, 15c back and forth between the first end position and the second end position at an adjustable speed and being controllable at least with respect to positioning of the body along the path. As will be described further in the following, the first chambers 13, the body 15a, 15b, 15c and the second chamber 16 are arranged such that by movement of the body 15a, 15b, 15c at least once between the first end position and the second end position, any pressure medium in the first chambers 13 is forced to the outlet 12 to exit the pressure intensifier unit 10.

In accordance with the embodiment of the present invention illustrated in FIG. 2, the actuating mechanism comprises means for supplying or extracting a working medium from the second chamber 16 comprising a source and a sink 17 of working medium in fluid communication with the second chamber 16 via a control valve (not shown in FIG. 2). The actuating mechanism may for example be a hydraulic mechanism, and the working medium may accordingly be hydraulic medium, such as hydraulic oil. The control valve may for example comprise or be constituted by a solenoid operated directional control valve and/or a hydraulic operated directional control valve. The control valve may be configured to cause movement of the body 15a, 15b, 15c within the second chamber 16, and possibly control the direction of the movement of the body 15a, 15b, 15c within the second chamber 16, by controllably supplying a portion of the second chamber 16 (e.g., the left-most portion of the second chamber 16 in FIG. 2) with working medium and draining working medium from a portion of the second chamber 16 (e.g., the right-most portion of the second chamber 16 in FIG. 2). To that end, the source and sink 17 of working medium may be connected with the portions of the second chamber 16 via working medium guiding passages 18a and 18b for guiding working medium, for example. The arrows on elements 18a and 18b denote the possible direction of flow of working medium in the working medium guiding passages 18a and 18b. Thus, in accordance with the embodiment of the present invention illustrated in FIG. 2, the actuating mechanism may further comprise the working medium guiding passages 18a and 18b, and will in the following be referred to by reference numerals 17, 18a, 18b. The controllable supplying of a portion of the second chamber 16 with working medium and draining of working medium from a portion of the second chamber 16 may for example be carried out by means of an electrohydraulic servo valve and/or a pump for the working medium (not shown in FIG. 2), which may be considered as part of the actuating mechanism 17, 18a, 18b. For example, and also in accordance with the embodiment of the present invention illustrated in FIG. 2, the body 15a, 15b, 15c may be constituted by a piston, or piston unit, the second chamber 16 may be constituted by a piston (unit) chamber, and the actuating mechanism 17, 18a, 18b may comprise a source and a sink of hydraulic fluid (e.g., hydraulic oil) in fluid communication with the piston chamber via a control valve. The control valve (not shown in FIG. 2) may be configured to cause movement of the piston within the piston chamber and optionally control the direction of the movement of the piston within the piston chamber by controllably supplying a portion of the piston chamber with hydraulic medium and draining hydraulic medium from a portion of the piston chamber.

By supplying a quantity of working medium to a portion of the second chamber 16 (e.g., the left-most portion of the second chamber 16 in FIG. 2) with working medium while at the same time draining a quantity of working medium from the other portion of the second chamber 16 (e.g., the right-most portion of the second chamber 16 in FIG. 2), the body 15a, 15b, 15c becomes axially displaced within the housing 19 along the longitudinal or central axis of the housing 19. Depending on the direction of movement of the body 15a, 15b, 15c during the axial displacement thereof, any pressure medium in either the first chamber 13 or the first chamber 14 may be discharged into the pressure medium guiding passage 7 or 8 and subsequently guided to the outlet 12 via a pressure medium guiding passage 51 or a pressure medium guiding passage 52. As any pressure medium in one of the first chamber 13 and the first chamber 14 is discharged, the other one of the first chamber 13 and the first chamber 14 may be filled with pressure medium supplied from the inlet 11 via pressure medium guiding passage 5 or 6. The quantity of working medium drained from the other portion of the second chamber 16 may correspond to the quantity of working medium supplied to the portion of the second chamber 16. Subsequently, the body 15a, 15b, 15c may be caused to become axially displaced within the housing 19 along the longitudinal or central axis of the housing 19 in the other direction by supplying a quantity of working medium to the portion of the second chamber 16 that was previously drained and at the same time draining a quantity of working medium from the other portion of the second chamber 16. Thereby, any pressure medium in the other one of the first chamber 13 and the first chamber 14 may be discharged into the pressure medium guiding passage 7 or 8 and subsequently guided to the outlet 12 via the pressure medium guiding passage 51 or the pressure medium guiding passage 52.

Thus, the first chambers 13, the body 15a, 15b, 15c and the second chamber 16 are arranged such that by movement of the body 15a, 15b, 15c at least once between the first end position and the second end position, any pressure medium in the first chambers 13 is forced to the outlet 12 to exit the pressure intensifier unit 10. While this has been described with reference to a specific example, a person skilled in the art recognizes in the light of the foregoing description that different configurations of the first chambers 13, 14, the body 15a, 15b, 15c and the second chamber 16 are possible in order to achieve that by movement of the body 15a, 15b, 15c at least once between the first end position and the second end position, any pressure medium in the first chambers 13, 14 is forced to the outlet 21 to exit the pressure intensifier unit 10. For example, while in accordance with the embodiment of the present invention illustrated in FIG. 2 the pressure intensifier unit may be configured in accordance with a double-acting single stage linear pressure intensifier such as the H2O Jet Intensifier pump manufactured by H2O Jet Inc., the HYPERTRON® High Pressure Pump manufactured by BFT, a STREAMLINE PRO® pump manufactured by KMT Waterjet Systems, or the HyperJet® Intensifier Pump manufactured by Flow Waterjet, it is to be understood that this is according to an example and not limiting embodiments of the present invention, which also encompass pressure intensifiers with a multiple stages (i.e., two or more stages) and/or not necessarily being linear ones, as well as similar devices having the same or similar working principles such as, for example, compressors.

It is to be understood that the pressure intensifier unit 10 illustrated in FIG. 2 may include one or more additional components, which however are not shown in FIG. 2. For example, the pressure intensifier unit 10 may include one or more non-return valves (check valves) in the pressure medium guiding passages 5, 6, 51 and 52 for preventing pressure medium from passing from one of the first chambers 13 and 14 into the other. Also, the pressure intensifier unit 10 may include at least one sensor which may be configured to sense position of the body 15a, 15b, 15c. The at least one sensor may be configured to sense position of the body 15a, 15b, 15c continuously (e.g., over the whole path). Possibly, the at least one sensor could be configured to (e.g., only) sense when the body 15a, 15b, 15c is in the first end position or in the second end position.

It is to be understood that a realization or implementation of the pressure intensifier unit 10 as described in the foregoing with reference to FIG. 2 is according to an example, and that other ways of realizing or implementing the pressure intensifier unit(s) are possible. For example, while the body 15a, 15b, 15c has been described in the foregoing as being constituted by a piston, or piston unit, the body (e.g., the part 15a) may (e.g., instead) include a membrane, and hence the pressure intensifier unit 10 may be a membrane-based pressure intensifier unit. Further, the actuating mechanism may not necessarily be a hydraulic mechanism, as described in the foregoing with reference to FIG. 2, but may instead (or additionally) be based on rotary direct drive or another type of direct drive, for example.

Each of the pressure intensifier units 10, 20, 30, 40 illustrated in FIG. 1 may be configured similarly to or the same as the pressure intensifier unit 10 illustrated in FIG. 2. With further reference to FIGS. 1 and 2, the control and/or processing unit 3 may be configured to control the actuating mechanisms 17, 18a, 18b of the pressure intensifier units 10, 20, 30, 40 such that each of the bodies 15a, 15b, 15c has a selected position in the corresponding second chamber 16 in relation to the position(s) of the other bodies 15a, 15b, 15c in their corresponding second chambers 16, and, subsequently, carry out a pressure increasing phase. The pressure increasing phase may comprise, for each pressure intensifier unit 10, 20, 30, 40, controlling the actuating mechanism 17, 18a, 18b to move the body 15a, 15b, 15c repeatedly back and forth between the first end position and the second end position while adjusting the speed for attaining a selected speed, thereby repeatedly forcing pressure medium in the first chambers 13, 14 to the outlet 12, 22, 32, 42 to exit the pressure intensifier unit 10, 20, 30, 40 and to be fed into the pressure vessel 2, and wherein the selected positions of the bodies 15a, 15b, 15c and/or the selected speed for each pressure intensifier unit 10, 20, 30, 40 are such that during at least a portion of the pressure increasing phase, the bodies 15a, 15b, 15c of at least some, possibly all, of the pressure intensifier units 10, 20, 30, 40 are in the first end position and in the second end position at different points in time and/or the speed is the same for at least some, possibly all, of the pressure intensifier units 10, 20, 30, 40. With further reference to FIG. 1, for each pressure intensifier unit 10, 20, 30, 40, each of the first chambers 13, 14 of the pressure intensifier unit 10, 20, 30, 40 is configured to continuously or continually receive the pressure medium having been received at the inlet 11, 21, 31, 41 of the pressure intensifier unit 10, 20, 30, 40 from the pressure medium source 4.

FIG. 3 is a schematic flowchart illustrating a method 100 according to an embodiment of the present invention. The method 100 is a method in a system comprising a plurality of pressure intensifier units. Each pressure intensifier unit is configured to increase the pressure in a pressure vessel for holding pressure medium by feeding pressure medium into the pressure vessel. Each pressure intensifier unit comprises an inlet configured to continuously or continually receive pressure medium, e.g., from a pressure medium source. Each pressure intensifier unit comprises an outlet configured to be connected to the pressure vessel for feeding pressure medium to the pressure vessel. Each pressure intensifier unit comprises at least one first chamber in fluid communication with the inlet and the outlet, respectively, and configured to continuously or continually receive the pressure medium having been received at the inlet. Each pressure intensifier unit comprises a body controllably movable within a second chamber (e.g., of the pressure intensifier unit) along a path back and forth between a first end position and a second end position. Each pressure intensifier unit comprises an actuating mechanism configured to controllably move the body back and forth between the first end position and the second end position at an adjustable speed, with the actuating mechanism being controllable at least with respect to positioning of the body along the path. For each pressure intensifier unit, the at least one first chamber, the body and the second chamber are arranged such that by movement of the body at least once between the first end position and the second end position, any pressure medium in the first chamber(s) is forced to the outlet to exit the pressure intensifier unit.

The method 100 comprises, at 101, controlling the actuating mechanisms of the pressure intensifier units such that each of the bodies has a selected position in the corresponding second chamber in relation to the position(s) of the other body or bodies in its or their corresponding second chamber(s). The method 100 comprises, at 102, subsequently carrying out a pressure increasing phase. The pressure increasing phase comprises, for each pressure intensifier unit, controlling the actuating mechanism to move the body repeatedly back and forth between the first end position and the second end position while adjusting the speed for attaining a selected speed, thereby repeatedly forcing pressure medium in the first chamber(s) to the outlet to exit the pressure intensifier unit and to be fed into the pressure vessel. The selected positions of the bodies and/or the selected speed for each pressure intensifier unit are such that during at least a portion of the pressure increasing phase, the bodies of at least some of the pressure intensifier units are in the first end position and in the second end position at different points in time and/or the speed is the same for at least some, possibly all, of the pressure intensifier units.

In conclusion, a system comprising a plurality of pressure intensifier units configured to increase the pressure in a pressure vessel is disclosed. Each pressure intensifier unit comprises an inlet and an outlet configured to be connected to the pressure vessel, at least one first chamber in fluid communication with the inlet and the outlet, respectively, a body controllably movable within a second chamber along a path back and forth between a first end position and a second end position, and an actuating mechanism configured to controllably move the body back and forth between the first end position and the second end position at an adjustable speed. A control and/or processing unit is configured to control the actuating mechanisms of the pressure intensifier units such that each of the bodies has a selected position in the corresponding second chamber in relation to the position(s) of the other body or bodies in its or their corresponding second chamber(s), and, subsequently, carry out a pressure increasing phase.

While the present invention has been illustrated in the appended drawings and the foregoing description, such illustration is to be considered illustrative or exemplifying and not restrictive; the present invention is not limited to the disclosed embodiments. Other variations to the disclosed embodiments can be understood and effected by those skilled in the art in practicing the claimed invention, from a study of the drawings, the disclosure, and the appended claims. In the appended claims, the word “comprising” does not exclude other elements or steps, and the indefinite article “a” or “an” does not exclude a plurality. The mere fact that certain measures are recited in mutually different dependent claims does not indicate that a combination of these measures cannot be used to advantage. Any reference signs in the claims should not be construed as limiting the scope.

1. A press apparatus comprising:
a pressure vessel;
a pressure medium source; and
a system comprising a plurality of pressure intensifier units, each pressure intensifier unit being configured to increase the pressure in the pressure vessel for holding pressure medium by feeding pressure medium into the pressure vessel;
wherein the press apparatus comprises or is constituted by an isostatic press apparatus configured to treat at least one article when placed in the pressure vessel by means of isostatic pressing;
wherein the pressure medium source is configured to be selectively in fluid communication with the pressure vessel via the pressure intensifier units of the system such that pressure medium can be transported from the pressure medium source to the pressure vessel via the pressure intensifier units;
each pressure intensifier unit comprising an inlet configured to continuously or continually receive pressure medium, an outlet configured to be connected to the pressure vessel for feeding pressure medium thereto, at least one first chamber in fluid communication with the inlet and the outlet, respectively, and configured to continuously or continually receive the pressure medium having been received at the inlet, a body controllably movable within a second chamber along a path back and forth between a first end position and a second end position, and an actuating mechanism configured to controllably move the body back and forth between the first end position and the second end position at an adjustable speed and being controllable at least with respect to positioning of the body along at least a part of the path, wherein the at least one first chamber, the body and the second chamber are arranged such that by movement of the body at least once between the first end position and the second end position, any pressure medium in the first chamber(s) is forced to the outlet to exit the pressure intensifier unit;
wherein each pressure intensifier unit is configured to receive pressure medium at the inlet of the pressure intensifier unit from the pressure medium source, and increase the pressure in the pressure vessel by feeding pressure medium into the pressure vessel, and wherein, for each pressure intensifier unit, the at least one first chamber of the pressure intensifier unit is configured to continuously or continually receive the pressure medium having been received at the inlet of the pressure intensifier unit from the pressure medium source;
the system further comprising at least one control and/or processing unit, configured to control the actuating mechanisms of the pressure intensifier units such that each of the bodies has a selected position in the corresponding second chamber in relation to the position(s) of the other body or bodies in its or their corresponding second chamber(s), and, subsequently, carry out a pressure increasing phase, comprising for each pressure intensifier unit controlling the actuating mechanism to move the body repeatedly back and forth between the first end position and the second end position while adjusting the speed for attaining a selected speed, thereby repeatedly forcing pressure medium in the first chamber(s) to the outlet to exit the pressure intensifier unit and to be fed into the pressure vessel, and wherein the selected positions of the bodies and the selected speed for each pressure intensifier unit are such that during at least a portion of the pressure increasing phase, the bodies of at least some of the pressure intensifier units are in the first end position and in the second end position at different points in time and the speed is the same for the at least some of the pressure intensifier units such that the time between consecutive changes of direction of the bodies at the end positions is the same for the at least some of the pressure intensifier units.

2. A press apparatus according to claim 1, wherein the controlling of the actuating mechanisms of the pressure intensifier units is such that each of the bodies has a selected position in the corresponding second chamber in relation to the position(s) of the other body or bodies in its or their corresponding second chamber(s) comprises:
controlling the actuating mechanisms of the pressure intensifier units based on the position of the body of a selected one of the pressure intensifier units such that the other body or bodies have selected positions in their respective second chambers in relation to the position of the body of the selected one of the pressure intensifier units, the selected one of the pressure intensifier units having been selected based on measurement data indicative of pressure medium feeding capacity of the pressure intensifiers unit obtained based on a previous pressure increasing phase.

3. A press apparatus according to claim 2, wherein, for each pressure intensifier unit, the actuating mechanism is further optionally controllable with respect to the direction of movement of the body along the path, and wherein the controlling of the actuating mechanisms of the pressure intensifier units is based on the position of the body of the selected one of the pressure intensifier units such that the other body or bodies have selected positions in their respective second chambers in relation to the position of the body of the selected one of the pressure intensifier units comprises, for each pressure intensifier unit other than the selected one of the pressure intensifier units, one or more of the following:
controlling of the actuating mechanism of the pressure intensifier unit to momentarily hold the body so as to attain the selected position in relation to the position of the body of the selected one of the pressure intensifier units;
controlling of the actuating mechanism of the pressure intensifier unit to momentarily decrease speed of the movement of the body so as to attain the selected position in relation to the position of the body of the selected one of the pressure intensifier units;
controlling of the actuating mechanism of the pressure intensifier unit to momentarily increase speed of the movement of the body so as to attain the selected position in relation to the position of the body of the selected one of the pressure intensifier units; and
controlling of the actuating mechanism of the pressure intensifier unit to change the direction of the movement of the body for attaining the selected position in relation to the position of the body of the selected one of the pressure intensifier units.

4. A press apparatus according to claim 1, further comprising at least one sensor configured to, for each pressure intensifier unit, sense position of the body;
wherein the at least one control and/or processing unit is further configured to, prior to said pressure increasing phase, for each pressure intensifier unit:
control the actuating mechanism to move the body repeatedly back and forth between the first end position and the second end position during a selected period of time;
obtain values indicative of the position of the body during the selected period of time at a plurality of time instants from the at least one sensor; and
based on the obtained values, determine a mean time required for the body to move between the first end position and the second end position;
the at least one control and/or processing unit further being configured to, prior to said pressure increasing phase:
compare the mean times determined for the respective ones of the pressure intensifier units to determine a largest mean time; and
control the actuating mechanisms of the pressure intensifier units based on the position of the body of the pressure intensifier unit(s) for which the determined mean time equals the largest mean time such that the other body or bodies have selected positions in relation to the position of the body of the pressure intensifier unit(s) for which the determined mean time equals the largest mean time, and, subsequently carry out said pressure increasing phase.

5. A press apparatus according to claim 4, wherein the at least one control and/or processing unit is configured to, during said pressure increasing phase, for each pressure intensifier unit:
obtain values indicative of the position of the body during a selected period of time at a plurality of time instants from the at least one sensor; and
based on the obtained values, determine a mean time required for the body to move between the first end position and the second end position;
the at least one control and/or processing unit further being configured to:
compare the mean times determined for the respective ones of the pressure intensifier units to determine a largest mean time; and
control the actuating mechanisms of the pressure intensifier units based on the position of the body of the pressure intensifier unit(s) for which the determined mean time equals the largest mean time such that the other body or bodies have selected positions in relation to the position of the body of the pressure intensifier unit(s) for which the determined mean time equals the largest mean time, and, subsequently, control the actuating mechanism to move the body repeatedly back and forth between the first end position and the second end position while adjusting the speed for attaining a selected speed, thereby repeatedly forcing pressure medium in the first chamber(s) to the outlet to exit the pressure intensifier unit and to be fed into the pressure vessel, and wherein the selected positions of the other body or bodies and the selected speed for each pressure intensifier unit are such that during at least a portion of time, the bodies of at least some of the pressure intensifier units are in the first end position and in the second end position at different points in time and the speed is the same for the at least some of the pressure intensifier units such that the time between consecutive changes of direction of the bodies at the end positions is the same for the at least some of the pressure intensifier units.

6. A press apparatus according claim 4, wherein, for each pressure intensifier unit, the actuating mechanism is optionally further controllable with respect to the direction of movement of the body along the path, and wherein the controlling of the actuating mechanisms of the pressure intensifier units based on the position of the body of the pressure intensifier unit(s) for which the determined mean time equals the largest mean time is such that the other body or bodies have selected positions in relation to the position of the body of the pressure intensifier unit(s) for which the determined mean time equals the largest mean time comprises, for each pressure intensifier unit other than the pressure intensifier unit(s) for which the determined mean time equals the largest mean time, one or more of the following:
controlling of the actuating mechanism of the pressure intensifier unit to momentarily hold the body so as to attain the selected position in relation to the position of the body in the pressure intensifier unit(s) for which the determined mean time equals the largest mean time;
controlling of the actuating mechanism of the pressure intensifier unit to momentarily decrease speed of the movement of the body so as to attain the selected position in relation to the position of the body in the pressure intensifier unit(s) for which the determined mean time equals the largest mean time;
controlling of the actuating mechanism of the pressure intensifier unit to momentarily increase speed of the movement of the body so as to attain the selected position in relation to the position of the body in the pressure intensifier unit(s) for which the determined mean time equals the largest mean time; and
controlling of the actuating mechanism of the pressure intensifier unit to change the direction of the movement of the body for attaining the selected position in relation to the position of the body in the pressure intensifier unit(s) for which the determined mean time equals the largest mean time.

7. A press apparatus according to claim 1, further comprising at least one sensor configured to, for each pressure intensifier unit, sense position of the body;
wherein the at least one control and/or processing unit is configured to, during said pressure increasing phase, for each pressure intensifier unit:
obtain values indicative of the position of the body during a selected period of time at a plurality of time instants from the at least one sensor; and
based on the obtained values, determine a plurality of mean times required for the body to move between the first end position and the second end position, the plurality of mean times corresponding to the respective ones of the different periods of time during said pressure increasing phase;
the at least one control and/or processing unit being further configured to:
compare the mean times determined for the respective ones of the pressure intensifier units to determine a pressure intensifier unit of the plurality of pressure intensifier units for which the mean time required for the body to move between the first end position and the second end position most often during said pressure increasing phase is the largest; and
control the actuating mechanisms of the pressure intensifier units based on the position of the body of the determined pressure intensifier unit such that the other body or bodies have selected positions in their respective second chambers in relation to the position of the body of the determined pressure intensifier unit, and subsequently carry out another pressure increasing phase, comprising controlling the actuating mechanism to move the body repeatedly back and forth between the first end position and the second end position while adjusting the speed for attaining a selected speed, thereby repeatedly forcing pressure medium in the first chamber(s) to the outlet to exit the pressure intensifier unit and to be fed into the pressure vessel, and wherein the selected positions of the other body or bodies and the selected speed for each pressure intensifier unit are such that during at least a portion of the other pressure increasing phase, the bodies of at least some of the pressure intensifier units are in the first end position and in the second end position at different points in time and the speed is the same for the at least some of the pressure intensifier units such that the time between consecutive changes of direction of the bodies at the end positions is the same for the at least some of the pressure intensifier units.

8. A press apparatus according to claim 1, wherein for each pressure intensifier unit, the body comprises or is constituted by a piston unit, the second chamber comprises or is constituted by a piston unit chamber, and the actuating mechanism comprises a source and a sink of hydraulic fluid in fluid communication with the piston unit chamber via a control valve configured to cause movement of the piston unit within the piston unit chamber and optionally control the direction of the movement of the piston unit within the piston unit chamber by controllably supplying at least a portion of the piston unit chamber with hydraulic medium and draining hydraulic medium from at least a portion of the piston unit chamber.

9. A method in a press apparatus comprising a pressure vessel, a pressure medium source, and a system comprising a plurality of pressure intensifier units, each pressure intensifier unit being configured to increase the pressure in the pressure vessel for holding pressure medium by feeding pressure medium into the pressure vessel, wherein the press apparatus comprises or is constituted by an isostatic press apparatus configured to treat at least one article when placed in the pressure vessel by means of isostatic pressing, wherein the pressure medium source is configured to be selectively in fluid communication with the pressure vessel via the pressure intensifier units of the system such that pressure medium can be transported from the pressure medium source to the pressure vessel via the pressure intensifier units, each pressure intensifier unit comprising an inlet configured to continuously or continually receive pressure medium, an outlet configured to be connected to the pressure vessel for feeding pressure medium thereto, at least one first chamber in fluid communication with the inlet and the outlet, respectively, and configured to continuously or continually receive the pressure medium having been received at the inlet, and a body controllably movable within a second chamber along a path back and forth between a first end position and a second end position, and an actuating mechanism configured to controllably move the body back and forth between the first end position and the second end position at an adjustable speed and being controllable at least with respect to positioning of the body along at least a part of the path, wherein the at least one first chamber, the body and the second chamber are arranged such that by movement of the body at least once between the first end position and the second end position, any pressure medium in the first chamber(s) is forced to the outlet to exit the pressure intensifier unit, wherein each pressure intensifier unit is configured to receive pressure medium at the inlet of the pressure intensifier unit from the pressure medium source, and increase the pressure in the pressure vessel by feeding pressure medium into the pressure vessel, and wherein, for each pressure intensifier unit, the at least one first chamber of the pressure intensifier unit is configured to continuously or continually receive the pressure medium having been received at the inlet of the pressure intensifier unit from the pressure medium source, the method comprising:
controlling the actuating mechanisms of the pressure intensifier units such that each of the bodies has a selected position in the corresponding second chamber in relation to the position(s) of the other body or bodies in its or their corresponding second chamber(s), and, subsequently, carrying out a pressure increasing phase, comprising for each pressure intensifier unit controlling the actuating mechanism to move the body repeatedly back and forth between the first end position and the second end position while adjusting the speed for attaining a selected speed, thereby repeatedly forcing pressure medium in the first chamber(s) to the outlet to exit the pressure intensifier unit and to be fed into the pressure vessel, and wherein the selected positions of the bodies and the selected speed for each pressure intensifier unit are such that during at least a portion of the pressure increasing phase, the bodies of at least some of the pressure intensifier units are in the first end position and in the second end position at different points in time and the speed is the same for the at least some of the pressure intensifier units such that the time between consecutive changes of direction of the bodies at the end positions is the same for the at least some of the pressure intensifier units.

10. A computer program comprising instructions, which when executed by one or more processors comprised in at least one control and/or processing unit in a system of a press apparatus according to claim 1, cause the at least one control and/or processing unit to perform a method according to claim 9.
